(19) United States
(12) Patent Application Publication
(10) Pub. No.: US 2010/0117355 A1
(43) Pub. Date: May 13, 2010

(54) HOSE COUPLING

(75) Inventor: Mark Allan Lamontia, Landenberg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/267,931

(22) Filed: Nov. 10, 2008

(51) Int. Cl. F16L 33/20

(52) U.S. Cl. 285/222.2

(57) ABSTRACT

This invention relates to an improved umbilical hose end coupling that is useful with textile-reinforced hoses in the oil and gas industry, especially high pressure hoses for use in offshore systems. This hose coupling comprises a sleeve and an insert for the sleeve, the insert having a hose end for insertion into the hose and the sleeve having a hose end for covering the exterior of the hose and the insert, and the insert and sleeve each having a coupling end for engaging each other, and the sleeve having an interior surface for gripping the hose, the interior surface having
i) distributed on the hose end, a plurality of grooves with at least one rounded annular tooth, and
ii) distributed on the coupling end, a plurality of grooves with rectangular annular teeth.

### BACKGROUND OF THE INVENTION

1. Field of the Invention

This invention relates to an improved umbilical hose coupling that is useful with textile-reinforced hoses in the oil and gas industry, especially high pressure hoses for use in offshore systems. It is also useful with other hoses.

2. Description of Related Art

FIG. 1 shows a perspective cut-away view of one prior art embodiment of a hose coupling 1 with a reinforced hose 2 having a layer of a textile 5 sandwiched between an inner liner 8 and an outer cover 7. The hose coupling has a sleeve 3 and an insert 4, each having a set of teeth in the area represented by 6 for engaging the hose when swaged or crimped. As shown in FIG. 1, the coupling is not yet swaged or crimped onto the hose. For the purposes herein, the end where the sleeve and insert engage each other is the coupling end while the end terminating at the hose is the hose end. For the purposes herein, the words crimped and swaged are used interchangeably to mean the sleeve is pressed or compressed onto the hose and insert.

U.S. Pat. No. 5,255,944 to Blin et al. and British Patent No. 992,378 to New disclose hose fittings having annular teeth for engaging a hose when the fittings are crimped onto the hose. In particular, both of these references disclose sleeves having either rectangular or trapezoidal teeth as the final teeth contacting the hose at the hose end of the coupling. These teeth have sharply defined edges; as the sleeve is crimped onto the hose, these sharp-edged projections embed into the hose covering. This ensures a good connection between the fitting and the hose.

FIG. 2 illustrates a cross-section for a prior art coupling 10 having a sleeve 3 swaged or crimped onto a hose 2, and engaging both the hose and the insert 4. The sleeve and insert are shown with sharp-edged or rectangular teeth. It has been found in some instances that when such hoses are put in use and pressurized, the hose fails at the hose end of the coupling in the general area designated by 11. It is thought the hose fails because the hose in the area 11 experiences highly localized stress created by the last sharp-edged rectangular tooth or teeth on the hose end of the sleeve. It is believed the sharp edge of the last tooth is so effective in rigidly penetrating into the covering that a stress concentration occurs at that area when the hose balloons out under pressure. Large, penetrating, sharp-edged projections or teeth on the sleeve at the hose end of the coupling, therefore, are thought to contribute to the failure of such hoses. What is needed, therefore, is an improved hose coupling that better distributes the load over a number of the teeth.

### BRIEF SUMMARY OF THE INVENTION

This invention relates to a hose coupling useful with a textile-reinforced hose, comprising a sleeve and an insert for the sleeve, the insert having a hose end for insertion into the hose and the sleeve having a hose end for covering the exterior of the hose and the insert, and the insert and sleeve each having a coupling end for engaging each other, and the sleeve having an interior surface for gripping the hose, the interior surface having:

i) distributed on the hose end, a plurality of grooves with at least one rounded annular tooth, and

ii) distributed on the coupling end, a plurality of grooves with rectangular annular teeth.

In another embodiment, the insert also has an exterior surface for gripping the hose, the exterior surface having:

i) distributed on the hose end, a plurality of grooves with at least one rounded annular tooth, and

ii) distributed on the coupling end, a plurality of grooves with rectangular annular teeth.

### BRIEF DESCRIPTION OF THE DRAWINGS

FIG. 1 is a perspective cut-away view of one prior art embodiment of an uncrimped hose coupling including a sleeve, an insert, and a hose.

FIG. 2 is a cross-section view of a prior art sleeve crimped onto a hose and insert.

FIG. 3A is one prior art hose coupling and FIG. 3B is one embodiment of the present invention of an improved hose coupling.

FIGS. 4A to 4F are various embodiments of possible combinations of various shapes, spacings, relative heights, and sizes of teeth and grooves on the surface of the sleeve and/or insert of the present invention.

FIGS. 5A to 5I are various embodiments of the present invention of possible rounded tooth shapes used on the sleeve and/or insert.

FIGS. 6 to 9 are some embodiments of the present invention of the hose couplings showing possible mechanical variations that can be used.

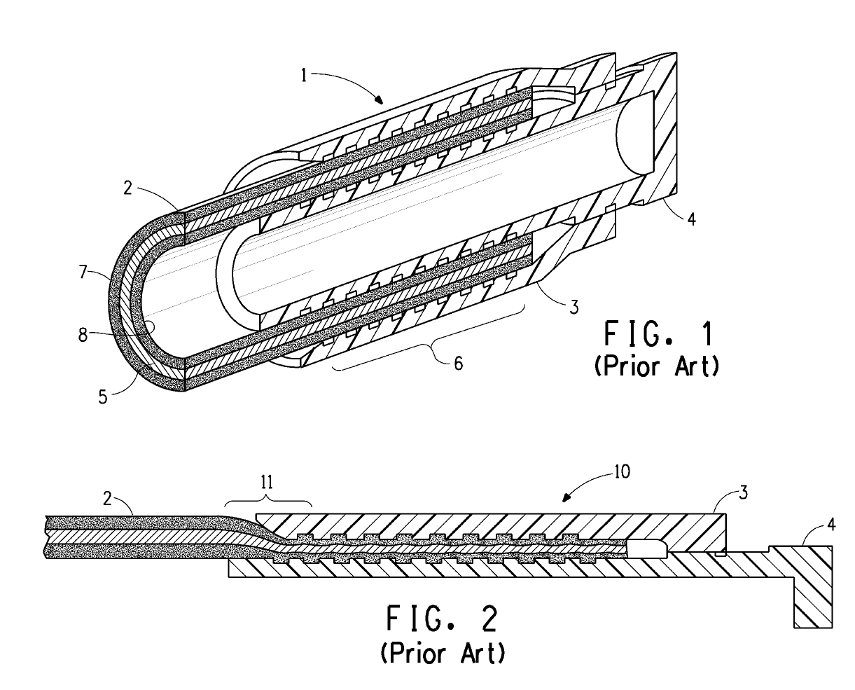

### DETAILED DESCRIPTION OF THE INVENTION

This invention relates to an improved hose coupling that is useful with high pressure textile-reinforced hoses in the oil and gas industry, the sleeve of the coupling having at least one rounded annular tooth at the hose end of the coupling and rectangular annular teeth at the coupling end of the coupling. It is thought that rounded teeth help reduce localized stresses in the hose at the hose end of the coupling, while the rectangular teeth securely hold the hose at the coupling end of the coupling. Hoses that fail at the hose end of the coupling under the influence of a pressure impulse or loading, usually fail in the region of contact between the hose and the first rectangular tooth on the hose end of the sleeve. The incidence of failure can be reduced if the hose can gripped by the coupling sleeve in a graduated manner, such that the load is better spread over a number of the teeth.

As used herein, the teeth and grooves on the sleeve and insert are understood to be annular, that is they form projections in the case of teeth or indentations in the case of grooves that are continuous around or into the interior of the sleeve or the exterior of the insert. In a preferred embodiment, the annular surface of the sleeve and insert is round; however, non-round sleeves or inserts are thought to be useful. By “continuous around or into” it is meant the teeth or grooves either create (1) substantially continuous circumferential interior and/or exterior bands, which in the case of a round sleeve or insert are generally ring-shaped grooves and teeth; or (2) substantially continuous helical interior and/or exterior bands, which in the case of a round sleeve or insert are generally spiral-shaped grooves and teeth similar to the threads on a screw or bolt. If desired, the sleeve and the insert can have different types of continuous projections or indentions. Also, the individual sleeve and insert can have on its exterior or interior surface a combination of these two types of continuous projections or indentations if desired.

In some preferred embodiments the grooves and teeth are positioned orthogonal to the axis of the sleeve and insert. In other words, these grooves and teeth are non-helical, meaning at least two of the indentations or grooves, and likewise the teeth or projections, are not connected by being continuous around the periphery like the threads of a screw; that is, at least two of the teeth and/or two of the grooves are spaced apart and separated from one another. In some embodiments, the grooves and teeth can be helically arranged on the annular surface of either the sleeve or insert. In some embodiments, combinations of orthogonal and helical teeth and grooves can used.

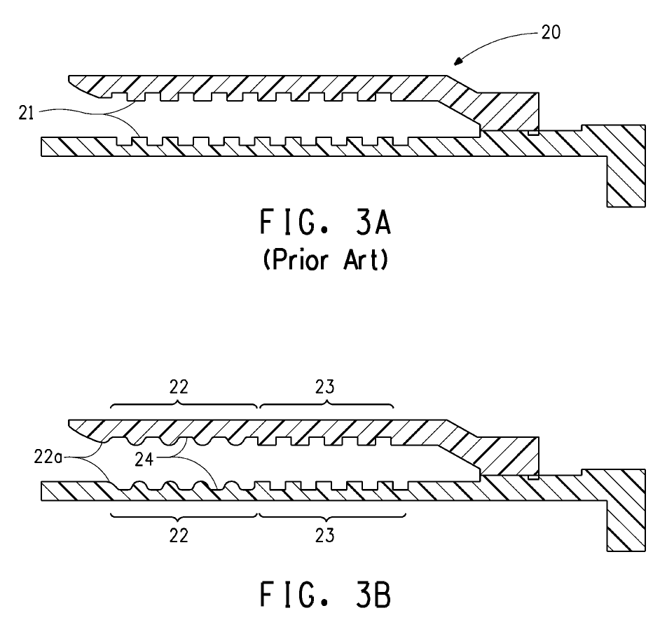

FIG. 3A is an illustration of a typical prior art uncrimped hose coupling and FIG. 3B is an illustration of one embodiment of an uncrimped hose coupling of the present invention having both rounded and rectangular teeth and non-helical or orthogonal grooves. Prior art coupling 20 has a series of identical rectangular teeth 21 shown on both the sleeve and the insert. The illustration in FIG. 3B of one preferred embodiment shows a plurality of substantially uniformly-spaced, rounded annular teeth 22 on the interior surface of the sleeve at the hose end. The interior surface of the sleeve also grips the hose with a plurality of substantially uniformly-spaced, rectangular annular teeth 23. The plurality of rounded and the plurality of rectangular teeth both form a plurality of non-helical annular grooves 24 between the teeth. In this illustration, the insert of the coupling also has plurality of substantially uniformly-spaced, non-helical annular grooves formed by rectangular annular teeth. As shown in this embodiment, the sleeve and the insert both have a plurality of rounded annular teeth. In addition, the exit shoulders 22A on the sleeve and the insert are also rounded. In one preferred embodiment, any exit shoulder on the sleeve and/or insert on any of the possible embodiments is also rounded.

The arrangement of teeth on the sleeve and the insert as shown in FIG. 3B is only one embodiment and many combinations of teeth are possible. FIGS. 4A to 4F illustrate other possible tooth and groove embodiments in accordance with the present invention. As shown in FIG. 4A, a plurality of uniformly-spaced, same-height rounded teeth are shown at the hose end as represented by 25 and a plurality of uniformly-spaced, same-height rectangular teeth are shown at coupling end as represented by 26. In FIG. 4B, the first two rounded teeth on the hose end 25 have different heights, while the next two have identical heights, and then two rectangular teeth on the coupling end 26 have the same height. While the figures illustrate a preferred embodiment wherein there is a plurality of rounded teeth on the hose end of the sleeve or the sleeve and insert, however, it is thought only one rounded tooth used as the last tooth of the sleeve or sleeve and insert is required. FIG. 4C illustrates the grooves between teeth of the present invention can be rounded or rectangular. FIG. 4D illustrates the set of rounded teeth of the present invention can be spaced apart from the rectangular teeth on the sleeve or sleeve and insert. FIG. 4E illustrates a combination of features can be used, including variable spacing of the teeth and/or grooves and different heights of both the rounded and rectangular teeth. As used herein, rectangular teeth are understood to be teeth having a sharp edge for projecting into the cover of a hose to grip the hose securely.

FIG. 4F illustrates one preferred embodiment for the combination of teeth on the sleeve or insert. This embodiment has a set of rectangular teeth at the coupling end, followed by a set of rounded teeth having rounded corners, with the radii of the rounded corners increasing as the teeth are positioned closer to the hose end, eventually becoming circular in cross-section. Further, the centerline height of each rounded tooth decreases as the position of the tooth gets closer to the hose end. Finally, this embodiment also illustrates an especially useful spacing or grooves between the teeth; this spacing is shown as being wider at the hose end, and gets progressively narrower toward the coupling end of the sleeve. Therefore, in some embodiments, the grooves and teeth are uniformly spaced, but if desired in some embodiments, the grooves and teeth have wider spacing at the hose end than at the coupling end.

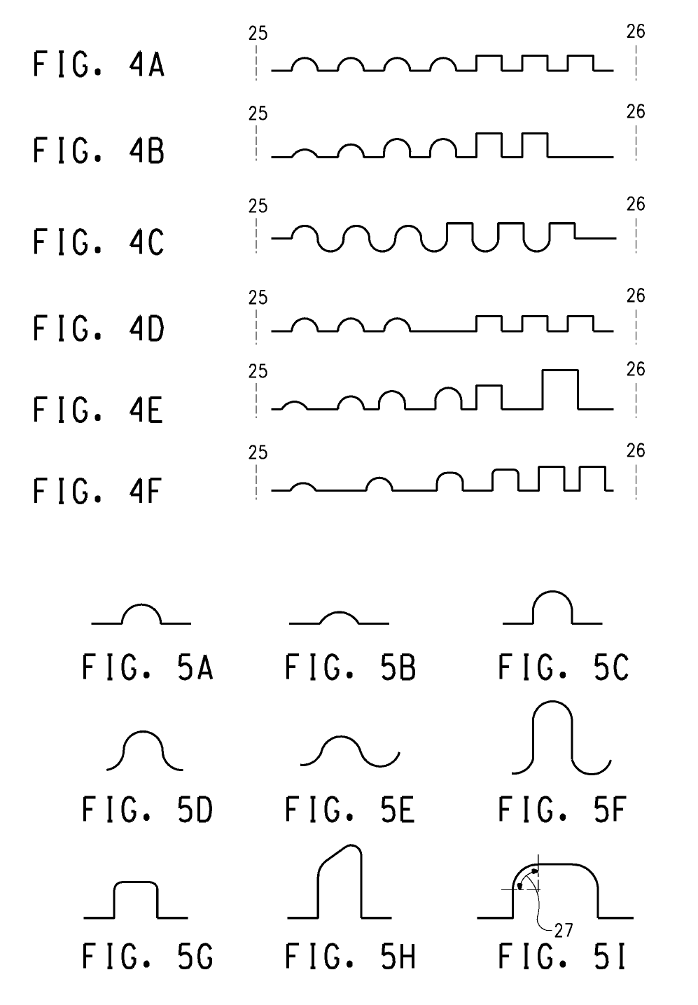

The rounded teeth and grooves of the present invention can be in many different forms and combinations as represented in FIGS. 5A through 51. As in FIGS. 5A to 5C, the rounded teeth can have flat grooves and be semi-circular in shape, be shaped from a portion of an arc of a circle, or have the shape of a projected semi-circular with straight sides. As shown in FIGS. 5D to 5F, the same shapes can be combined with rounded grooves. In addition, as shown in FIGS. 5G to 5I teeth having a flat top with rounded edges can also be used as rounded teeth. The flat top can be parallel to the annular axis of the sleeve as shown in FIG. 5G or can be at an angle to the axis as shown in FIG. 5H, as long as the sharp edges are rounded. By rounded edges for these flat top teeth, it is meant the teeth are provided with a circular radius 27 as shown in FIG. 5I that can be machined or otherwise created or formed on the teeth to avoid sharp edges. In some embodiments this radius is from one-tenth to one-third the width of the tooth. In one embodiment there is a plurality of rounded teeth, each tooth having a set of rounded edges, wherein the radius of the set of rounded edges on each tooth is progressively larger from the coupling end to the hose end.

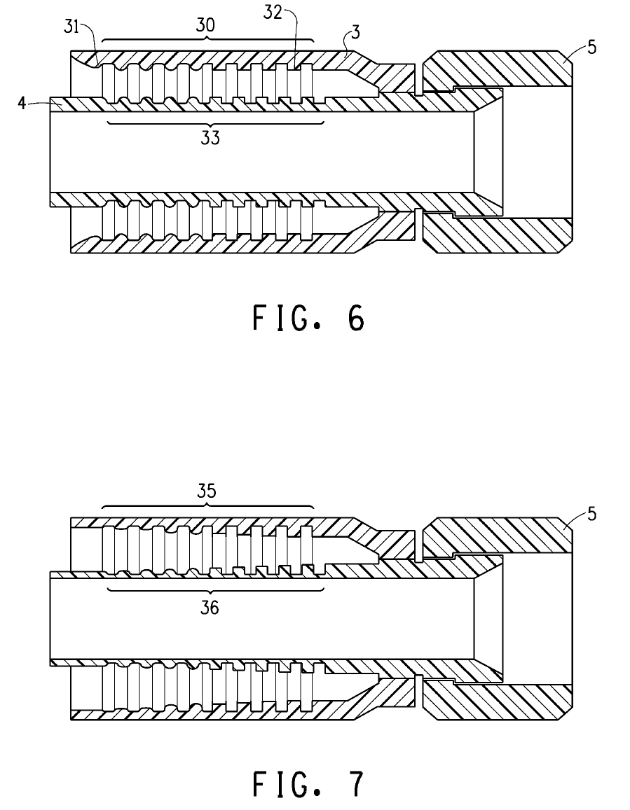

FIG. 6 illustrates a coupling sleeve 3 of the present invention uncrimped on an insert 4, and included in this illustration is the coupling device 5, such as a hex-shaped threaded nut, used to attach the hose to another object. The type of coupling device is not critical and while all illustrations do not show such a coupling device, it should be understood that the purpose of the hose coupling, comprising the sleeve and insert, is to attach the hose to something and therefore some type of coupling device can be and will normally be attached to the coupling end of the hose coupling. In some instances, the coupling device could be another hose coupling.

The embodiment of FIG. 6 illustrates a set of annular teeth and grooves 30 on the interior of the sleeve and a set of annular teeth and grooves 33 on the exterior of the insert. The last tooth 31 on the hose end of the sleeve is shown slightly rounded, as is the adjacent shoulder of the sleeve, while the last tooth 32 on the coupling end of the sleeve is shown as rectangular.

As shown in the hose coupling FIGS. 6 to 9 of the present invention, a plurality of rectangular teeth is shown at the coupling end, followed by a number of teeth having either round shape or other rounded teeth having a pseudo-rectangular shape with rounded corners at the hose end. While not to imply any particular method of generating either the sleeve or the insert, due to the ease at which parts can be machined, if desired, after at least two rectangular teeth are present at the coupling end of the sleeve, the remaining teeth on the sleeve can be machined to have rounded corners with the radius of those corners being progressively larger as the teeth are machined toward the hose end. If desired the entire tooth can have a semi-circular shape, or the tooth can have a portion of an arc of a circle, especially the final teeth at the hose end.

FIG. 7 illustrates an embodiment wherein the sleeve has a set of teeth 35 having different heights. Also, if desired, the insert can have a set of teeth 36 having different heights. In this embodiment, the teeth vary from slightly rounded to rectangular as in FIG. 6, however, the height of the teeth increase as the roundness of the teeth decrease. As shown in this illustration, the wall thickness of the sleeve, as defined as the thickness of the wall in the groove, does not substantially vary from the coupling end to the hose end of either the sleeve or the insert.

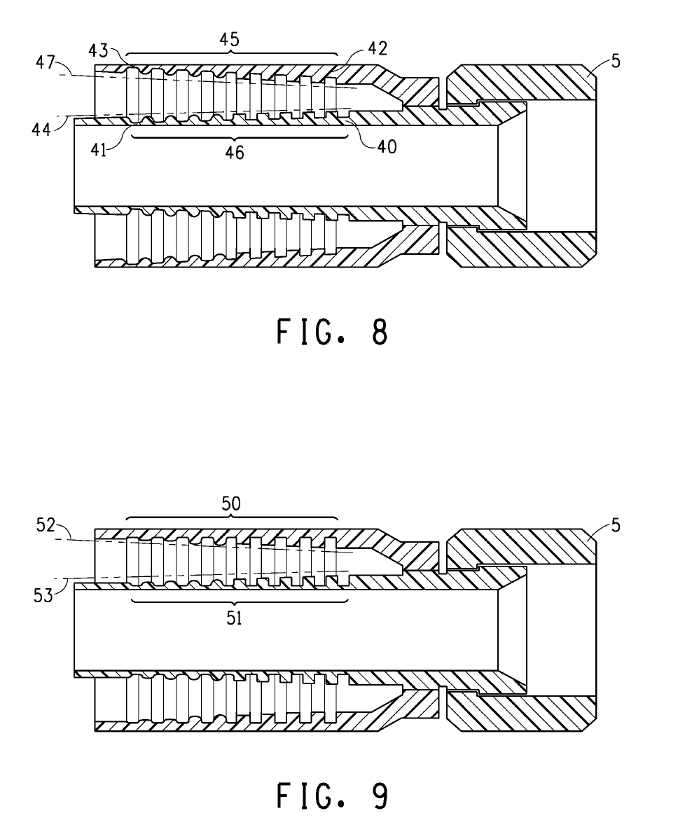

FIG. 8 illustrates an embodiment wherein the sleeve has a set of teeth 45 wherein the inside radius from the centerline of the coupling to the annular tooth surface increases from the coupling end to the hose end. Dotted line 47 illustrates the angle formed by the increasing radii of the teeth. Also in this embodiment, the centerline height of individual teeth on the sleeve can be the same, and the wall thickness as defined by the thickness in the groove increases from a thick wall thickness at groove 42 to a thin wall thickness at groove 43. If desired, the coupling can include on the insert a similar set of teeth 46 that have an outside radius from the centerline of the coupling to the annular tooth surface that decreases from the coupling end to the hose end. Dotted line 44 illustrates the angle formed by the decreasing radii of the teeth. As with the sleeve, the centerline height of individual teeth on the insert can be the same, and the wall thickness as defined by the thickness in the groove increases from a thick wall thickness at groove 40 to a thin wall thickness at groove 41.

FIG. 9 illustrates an embodiment combining a substantially constant wall thickness, as defined by the thickness of the groove, with the variation in radius as described for FIG. 6. The set of teeth 50 for the sleeve is shown again with dotted line 52 illustrating the angle formed by the increasing radii of the annular teeth on the sleeve. If desired the insert can have a set of teeth 51 that have an outside radius from the centerline of the coupling to the annular tooth surface that decreases from the coupling end to the hose end. Dotted line 53 illustrates the angle formed by the decreasing radii of the teeth. As with the sleeve, the centerline height of individual teeth on the insert decreases from the coupling end to the hose end and the wall thickness as defined by the thickness of the wall of the sleeve or insert in the groove remains substantially constant from the hose end to the coupling end.

As shown in the above illustrations, in some embodiments of the present invention the wall thickness of the hose end of the sleeve is smaller than at the coupling end, the wall thickness being defined as the thickness of the wall in the groove. In some embodiments of the invention, there is a plurality of rounded annular teeth and the centerline height of all the rounded annular teeth is the same. In some other embodiments of the invention, the centerline height of all the rectangular annular teeth is the same. In some other embodiments of the invention, the centerline height of the each of the annular teeth varies linearly from the coupling end to the hose end. In some other embodiments of the invention, the height of the teeth vary gradually and continuously in something other than a linear variation, such as a logarithmic or parabolic variation. In some preferred embodiments of the invention, the centerline height of each tooth decreases from the coupling end to the hose end. In particular, the centerline heights of the rounded annular teeth at the hose end are smaller than the centerline heights of the rectangular annular teeth at the coupling end. These embodiments can apply equally to the sleeve or the insert.

While the above are useful, other embodiments and combinations of features can be used to form suitable hose couplings. The hose coupling is especially useful with textile reinforced hoses, but the hose coupling can also be used with other hoses such as those having other types of layered reinforcement, such as metal reinforcement; or hoses having limited or no reinforcing layers. In some embodiments such hoses include a thermoplastic covering, a section of textile reinforcement, and a liner. In others, the hose can simply be thermoplastic or elastomeric.

Suitable materials useful as covers for the hoses include thermoplastic and/or elastomeric materials or various combinations thereof. Suitable materials useful as liners for the hoses include thermoplastic, elastomeric, and/or fluoropolymer or various combinations thereof. While these materials are especially typical of hoses, essentially any material useful for a hose can be used.

The textile reinforcement can include fiber or yarn that is braided, or the fiber or yarn can be spirally or helically oriented in the hose. The textile reinforcement can also be wound fiber tapes. The preferred textile reinforcement includes aramid fiber, and most preferred aramid is poly(paraphenylene terephthalamide). Other types of fibers and yarns, such as polyamides, polyesters, glass fiber, carbon fiber, ceramic fiber, and other high strength aramids, polyazoles, extended chain polyetheylenes, and liquid crystal polyesters, or mixtures of any of these materials could also be used if desired.

What is claimed is:

1. A hose coupling useful with a textile-reinforced hose, comprising:
a sleeve and an insert for the sleeve;
the insert having a hose end for insertion into the hose and the sleeve having a hose end for covering the exterior of the hose and the insert; and
the insert and sleeve each having a coupling end for engaging each other;
the sleeve also having an interior surface for gripping the hose, the interior surface having:
i) distributed on the hose end, a plurality of grooves with at least one rounded annular tooth, and
ii) distributed on the coupling end, a plurality of grooves with rectangular annular teeth.

2. The hose coupling of claim 1, wherein the sleeve has a wall thickness, the wall thickness of the hose end of the sleeve being smaller than at the coupling end.

3. The hose coupling of claim 1, wherein there is a plurality of rounded teeth and the centerline height of all the rounded annular teeth is the same, or wherein the centerline height of all the rectangular annular teeth is the same.

4. The hose coupling of claim 1, wherein there is a plurality of rounded teeth, each tooth having a set of rounded edges, wherein the radius of the set of rounded edges on each tooth is progressively larger from the coupling end to the hose end.

5. The hose coupling of claim 1, wherein the centerline height of the each of the annular teeth varies from the coupling end to the hose end.

6. The hose coupling of claim 5, wherein the centerline heights of the rounded annular teeth at the hose end are smaller than the centerline heights of the rectangular annular teeth at the coupling end.

7. The hose coupling of claim 1, wherein the insert also has an exterior surface for gripping the hose, the exterior surface having
i) distributed on the hose end, a plurality of grooves with at least one rounded annular tooth, and
ii) distributed on the coupling end, a plurality of grooves with rectangular annular teeth.

8. The hose coupling of claim 7, wherein the insert has a wall thickness, the wall thickness of the hose end of the insert being smaller than at the coupling end.

9. The hose coupling of claim 7, wherein there is a plurality of rounded teeth and the centerline height of all the rounded annular teeth is the same, or wherein the centerline height of all the rectangular annular teeth is the same.

10. The hose coupling of claim 7, wherein there is a plurality of rounded teeth, each tooth having a set of rounded edges, wherein the radius of the set of rounded edges on each tooth is progressively larger from the coupling end to the hose end.

11. The hose coupling of claim 7, wherein the centerline height of the each of the annular teeth of the insert varies from the coupling end to the hose end.

12. The hose coupling of claim 11, wherein the centerline heights of the rounded annular teeth at the hose end are smaller than the centerline heights of the rectangular annular teeth at the coupling end.

13. A hose comprising the coupling of claim 1.

14. A hose comprising the coupling of claim 7.
